(19) United States
(12) Patent Application Publication
(10) Pub. No.: US 2002/0037474 A1
(43) Pub. Date: Mar. 28, 2002

(54) Memory Layer of high-density recordable optical recording

(76) Inventors: Wen-Yih Liao, Taichung City (TW); Andrew Teh Hu, Hsinchu (TW); Chien-Liang Huang, Taoyuan (TW); Huei-Wen Yang, Taoyuan Hsien (TW); Yun-Chiao Chen, Taipei Hsien (TW); Wen-Hsin Yen, Kaohsiung (TW); Tzuan-Ren Jeng, Yunlin Hsien (TW); Der-Ray Huang, Kuang-Ming Hsin Tsun (TW); Ding-Yih Hu, Taipei (TW); Ming-Chia Lee, Taichung Hsien (TW)

Correspondence Address: J.C. Patents, Inc., 4 Venture, Suite 250, Irvine, CA, 92618, US

(21) Appl. No.: 09/727,645

(22) Filed: Dec. 1, 2000

(30) Foreign Application Priority Data
Sep. 20, 2000 (TW) 89119319

(51) Int. Cl. G11B 7/24

(52) U.S. Cl. 430/270.21; 369/288; 430/945; 428/64.8

(57) ABSTRACT

A high-density recordable optical recording disk with a cyanine dye mixture as a recording layer. The cyanine dye mixture at least comprises cyanine dye I and cyanine dye II. The structure formula of cyanine dye I and cyanine dye II are shown as follows:

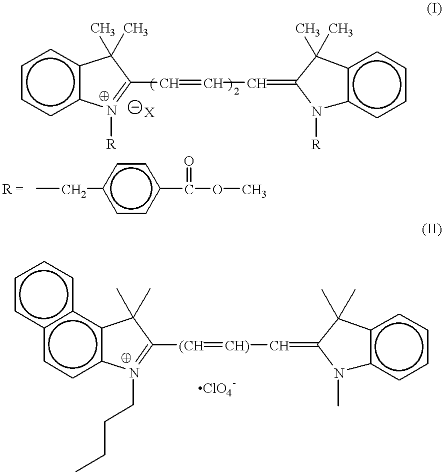

wherein R is a phenylester group and X⁻ is an acid anion.

### CROSS-REFERENCE TO RELATED APPLICATION

This application claims the priority benefit of Taiwan application serial no. 89119319, filed Sep. 20, 2000.

### BACKGROUND OF THE INVENTION

1. Field of the Invention

The present invention relates to a memory layer of a high-density recordable optical recording disk. More particularly, the present invention relates to a memory layer of a high-density recordable optical recording disk with a cyanime dye mixture as a recording layer material thereon.

2. Description of the Related Art

At the end of 1960, Klaas Compaan and Piet Kramer et al. in Philips research center developed a new concept about optical recording disks. Up to the beginning of 1980, the related optical recording disk was openly available to public. According to the recording method of this optical recording disk, optical recording disks comprise read-only optical recording disks, write-once read-many optical recording disks and erasable optical recording disks.

During the writing and recording processes of the recordable optical recording disk, a laser melts or dissolves the dye material layer on the optical recording disk to form concavities for recording. During the reading process of the recordable optical recording disk, the intensities of the reflection from the surface of the dye material layer and the concavities are converted into digital 0 and 1.

The dye material can be coated on the substrate by spin coating. Compared to the vacuum sputtering method for coating the metal material on the optical recording disk, coating the organic dye material on the substrate can simplify the process procedures. Additionally, the cost can be decreased. Therefore, many patents such as U.S. Pat. 4,767,693, U.S. Pat. No. 5,019,476, U.S. Pat. No. 5,292,615, U.S. Pat. No. 5,328,802, U.S. Pat. No. 5,332,608, U.S. Pat. No. 5,424,171, U.S. Pat. No. 5,455,094, etc. focus on developing an organic dye material as a recording material layer on the recordable optical recording disk.

### SUMMARY OF THE INVENTION

The invention provides a composition of a cyanine dye mixture as a recording layer material. An acceptable solvent is coated on a circular substrate to control the coating process and to manufacture a high-density recordable optical material.

The invention uses the composition of a cyanine dye mixture as a recording layer material. The mixture has a chemical stability and a well solubility for organic solvent.

The high-density recordable optical material at least comprises a mixture having cyanine dye I and cyanine dye II, or a mixture having cyanine dye I and cyanine dye III. The structure formulas of the cyanine dyes of the invention are shown below:

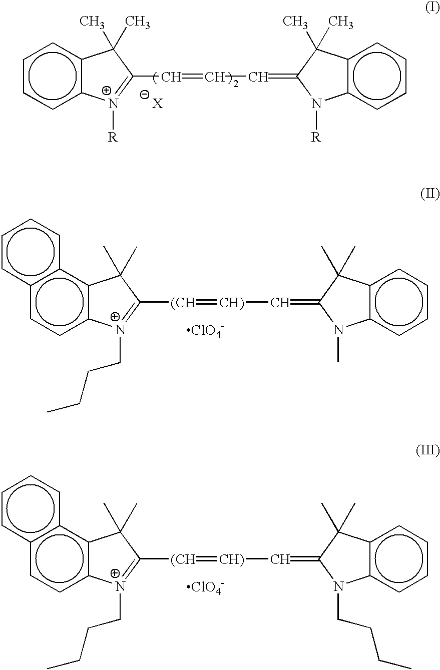

wherein R represents phenylester group and X⁻ represents acid anion, halogen anion (such as Cl⁻, Br⁻ and I⁻), alkylsulfate anion (such as CH₃SO₄⁻, C₂H₅SO₄⁻ and n-C₃H₇SO₄⁻.), aeylsulfonate anion (such as

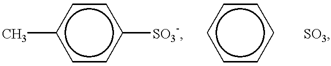

etc.), perchlorate anion (such as ClO₄⁻ etc.), etc.

The cyanine dye mixture further comprises a photo-stabilizer, whose structure formula is shown below:

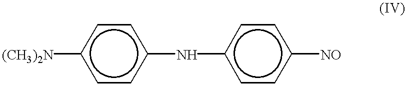

The cyanine dye mixture can dissolve in organic solvent, such 2,2,3,3-tetrafluoro-1-propanol, alcohol, ketone, ether, chloroform, dichloromethane, or dimethylformamide (DMF).

A phenylester group, which is an electron drawing group, is added to the N atom of indolenine of cyanine dye I to improve chemical stability and solubility for the organic solvent.

The cyanine dye mixture described above is coated on a substrate, which possesses several spiral homocentric grooves and lands. The substrate has a pre-molten information for providing a message, which records a required power and a wave type to a recording system.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 is an absorption spectrum of the reflection ratio versus wave length of a cyanine dye mixture of a first embodiment of the invention;

FIG. 2 is an absorption spectrum of the reflection ratio versus wave length of a cyanine dye mixture of a second embodiment of the invention;

FIG. 3 is an absorption spectrum of the reflection ratio versus wave length of a cyanine dye mixture of a third embodiment of the invention; and

FIG. 4 is an absorption spectrum of the reflection ratio versus wavelength of a cyanine dye mixture of a fourth preferred embodiment of the invention.

### DESCRIPTION OF THE PREFERRED EMBODIMENT

Materials used to form recording layers comprise cyanine dyes, phthalocyanine dyes, tetrahydrocholine dyes, anthraquinone dyes, xanthene dyes, triphenylmethane dyes, croconium dyes, pyrylium dyes, azulene dyes, etc. Materials used to form a recording layer of a DVD-recordable disk comprises cyanine dyes and azo dyes.

The invention provides cyanine dye mixtures to form memory layers. The cyanine dye mixtures improve chemical stability and solubility for organic solvents so that a quality high-density recordable optical recording disk is manufactured.

### First Embodiment

The dye used to form the recording material layer of the high-density recordable optical recording disk in this embodiment comprises a cyanine dye mixture of cyanine dye I and cyanine dye II. The structure formulas of cyanine dye I and cyanine dye II of the invention are shown below:

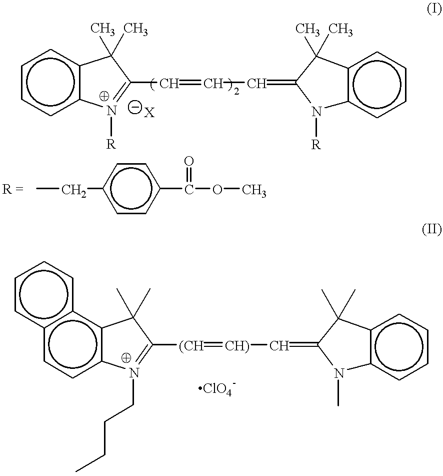

The cyanine dye mixture comprises cyanine dye I and cyanine dye II and is dissolved in a solvent, such as 2,2,3,3-tetrafluoro-1-propanol, to form a solution. In the solution, the weight percentage of the cyanine dye mixture to the total solution is about 0.5-8%. Preferably, the weight percentage of the cyanine dye mixture to the total solution is about 1-4%. The weight percentage of cyanine dye I to cyanine dye II is about 1-8%. Preferably, the weight percentage of cyanine dye I to cyanine dye II is about 4-6%.

The mixed solution mentioned above is coated on the blank substrate to form a dye layer. The dye layer is used as a recording layer of the optical recording layer. Moreover, the blank substrate possesses a thickness of about 0.6 mm and a diameter of about 120 mm. The blank substrate can be formed from polycarbonate, for example. Furthermore, the substrate possesses several spiral homocentric grooves, wherein the depth of the grooves is about 100-250 nm. After coating the recording layer, a reflection layer is formed on the recording layer. The thickness of the reflection layer is about 400-1500 Å, and the reflection layer can be selected from a group consisting of gold, argentum, aluminum and copper-chromium alloy. After that, the substrate is attached to another blank substrate formed from polycarbonate.

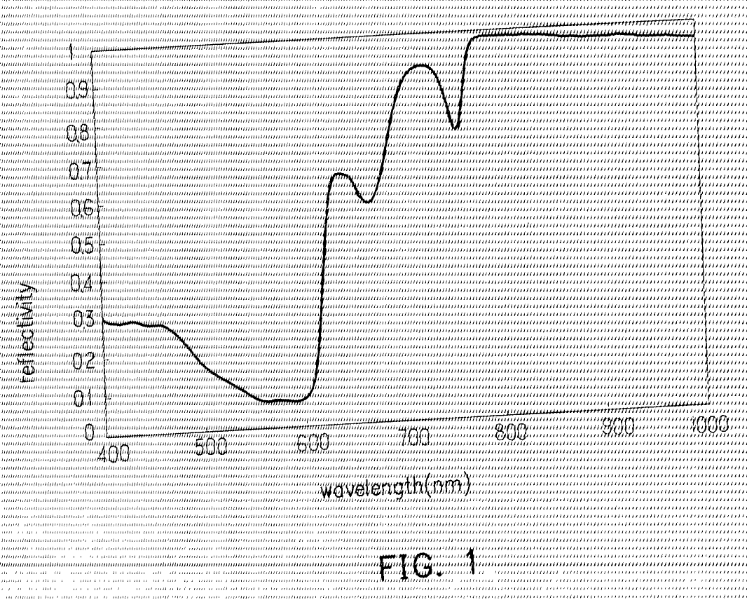

A mixture, which the ratio of cyanine dye I to cyanine dye II is 1:10, is used as a recording layer. A high-density recordable optical recording disk is formed from using the recording described above and using an Ag layer as a reflection layer. An absorption spectrum of the reflection ratio versus wave length of the high-density recordable optical recording disk is shown in FIG. 1. As shown in the figure, the reflection ratio of the optical recording disk reaches 50% when the wavelength is about 630 nm to 650 nm.

### Second Embodiment

The dye used to form the recording material layer of the high-density recordable optical recording disk in this embodiment comprises a cyanine dye mixture of cyanine dye I and cyanine dye III. The structure formulas of cyanine dye I and cyanine dye III of the invention are shown below:

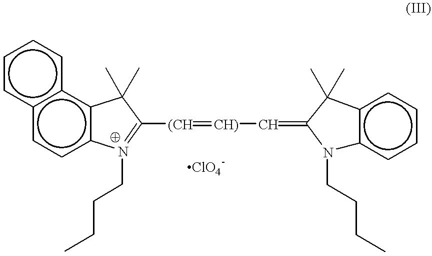

The cyanine dye mixture comprises cyanine dye I and cyanine dye III and is dissolved in a solvent, such as 2,2,3,3-tetrafluoro-1-propanol, to form a solution. In the solution, the weight percentage of the cyanine dye mixture to the total solution is about 0.5-8%. Preferably, the weight percentage of the cyanine dye mixture to the total solution is about 1-4%. The weight percentage of cyanine dye I to cyanine dye III is about 1-8%. Preferably, the weight percentage of cyanine dye I to cyanine dye III is about 4-6%.

The mixed solution mentioned above is coated on the blank substrate to form a dye layer. The dye layer is used as a recording layer of the optical recording layer. Moreover, the blank substrate possesses a thickness of about 0.6 mm and a diameter of about 120 mm. The blank substrate can be formed from polycarbonate, for example. Furthermore, the substrate possesses several spiral homocentric grooves, wherein the depth of the grooves is about 100-250 nm. After coating the recording layer, a reflection layer is formed on the recording layer. The thickness of the reflection layer is about 400-1500 Å and the reflection layer can be selected from a group consisting of gold, argentum, aluminum and copper-chromium alloy. After that, the substrate is attached to another blank substrate formed from polycarbonate.

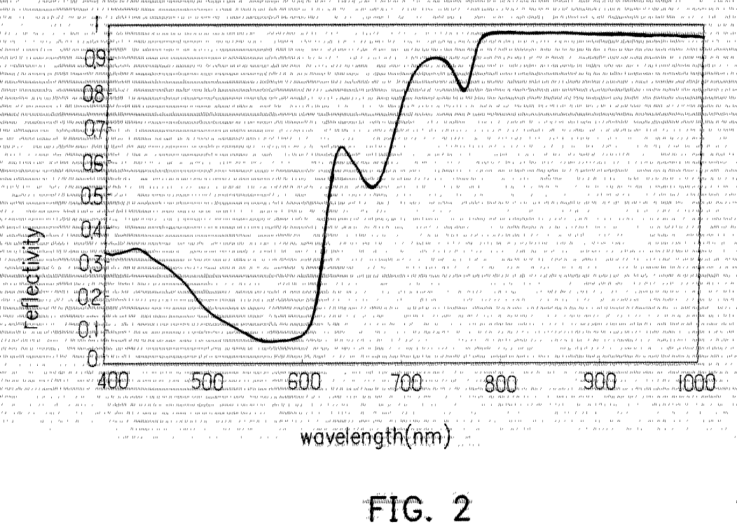

A mixture, which the ratio of cyanine dye I to cyanine dye III is 1:10, is used as a recording layer. A high-density recordable optical recording disk is formed from using the recording described above and using an Ag layer as a reflection layer. An absorption spectrum of the reflection ratio versus wave length of the high-density recordable optical recording disk is shown in FIG. 2. As shown in the figure, the reflection ratio of the optical recording disk reaches 50% when the wavelength is about 630 nm to 650 nm.

### Third Embodiment

The dye used to form the recording material layer of the high-density recordable optical recording disk in this embodiment comprises a cyanine dye mixture of cyanine dye I, cyanine dye II and a photo-stabilizer IV. The structure formula of the photo-stabilizer IV is shown below:

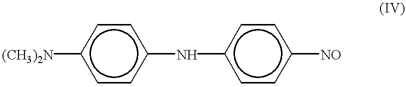

The cyanine dye mixture is dissolved in a solvent, such as 2,2,3,3-tetrafluoro-1-propanol, to form a solution. In the solution, the weight percentage of the cyanine dye mixture to the total solution is about 0.5-8%. Preferably, the weight percentage of the cyanine dye mixture to the total solution is about 1-4%. The weight percentage of cyanine dye I to the cyanine dye II is about 1-15%. Preferably, the weight percentage of cyanine dye I to the cyanine dye II is about 4-6%. The weight percentage of the photo-stabilizer IV to the cyanine dye II is about 1-15%. Preferably, the weight percentage of the photo-stabilizer IV to the cyanine dye II is about 3-8%.

The mixed solution mentioned above is coated on the blank substrate to form a dye layer. The dye layer is used as a recording layer of the optical recording layer. Moreover, the blank substrate possesses a thickness of about 0.6 mm and a diameter of about 120 mm. The blank substrate can be formed from polycarbonate, for example. Furthermore, the substrate possesses several spiral homocentric grooves, wherein the depth of the grooves is about 100-250 nm. After coating the recording layer, a reflection layer is formed on the recording layer. The thickness of the reflection layer is about 400-1500 Å and the reflection layer can be selected from a group consisting of gold, argentum, aluminum and copper-chromium alloy. After that, the substrate is attached to another blank substrate formed from polycarbonate.

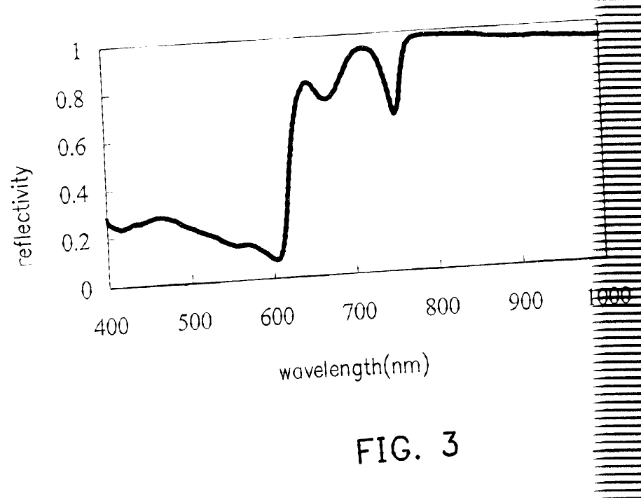

A mixture, which the weight ratio of cyanine dye I to cyanine dye II to the photo-stabilizer is 2:20:1, is used as a recording layer. A high-density recordable optical recording disk is formed from using the recording described above and using an Ag layer as a reflection layer. An absorption spectrum of the reflection ratio versus wave length of the high-density recordable optical recording disk is shown in FIG. 3. As shown in the figure, the reflection ratio of the optical recording disk reaches 45% when the wavelength is about 630 nm to 650 nm.

### Fourth Embodiment

The dye used to form the recording material layer of the high-density recordable optical recording disk in the embodiment comprises a cyanine dye mixture of cyanine dye I, cyanine dye III and a photo-stabilizer IV. The cyanine dye mixture is dissolved in a solvent, such as 2,2,3,3-tetrafluoro-1-propanol, to form a solution. In the solution, the weight percentage of the cyanine dye mixture to the total solution is about 0.5-8%. Preferably, the weight percentage of the cyanine dye mixture to the total solution is about 1-4%. The weight percentage of cyanine dye I to the cyanine dye II is about 1-15%. Preferably, the weight percentage of cyanine dye I to cyanine dye II is about 4-6%. The weight percentage of the photo-stabilizer IV to the cyanine dye II is about 1-15%. Preferably, the weight percentage of the photo-stabilizer IV to cyanine dye II is about 3-8%.

The mixed solution mentioned above is coated on the blank substrate to form a dye layer. The dye layer is used as a recording layer of the optical recording layer. Moreover, the blank substrate possesses a thickness of about 0.6 mm and a diameter of about 120 mm. The blank substrate can be formed from polycarbonate, for example. Furthermore, the substrate possesses several spiral homocentric grooves, wherein the depth of the grooves is about 100-250 nm. After coating the recording layer, a reflection layer is formed on the recording layer. The thickness of the reflection layer is about 400-1500 Å, and the reflection layer can be selected from a group consisting of gold, argentum, aluminum and copper-chromium alloy. After that, the substrate is attached to another blank substrate formed from polycarbonate.

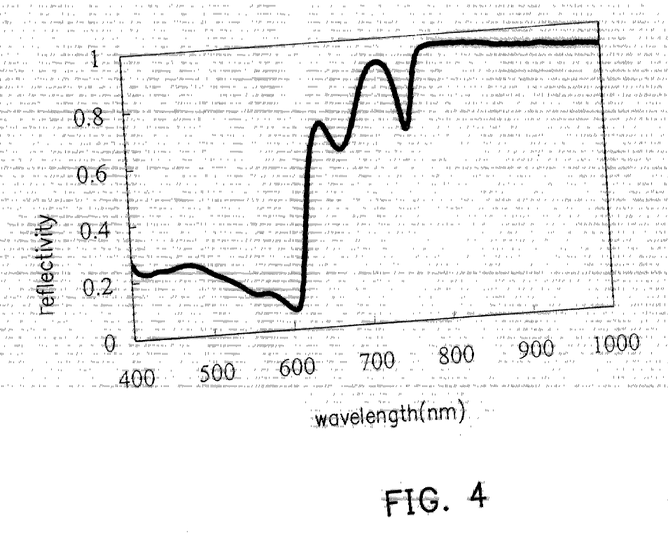

A mixture, which the weight ratio of cyanine dye I to cyanine dye II to the photo-stabilizer is 2:20:1, is used as a recording layer. A high-density recordable optical recording disk is formed from using the recording described above and using an Ag layer as a reflection layer. An absorption spectrum of the reflection ratio versus wavelength of the high-density recordable optical recording disk is shown in FIG. 4. As shown in the figure, the reflection ratio of the optical recording disk reaches 45% when the wavelength is about 630 nm to 650 nm.

### Reading and Writing Testing

Every factor of the first embodiment's optical recording disk is measured after performing the writing and recording processes. The conditions for reading and accessing the EFM signal are as follows:

The linear velocity is about 3.8 m/s; the wavelength is about 637.8 nm; the numerical aperture is about 0.6; the writing and recording power is about 6-15 mW and the reading power is about 0.5-2 mW. Obviously, the high-density recording disk with a recording made later from cyanine dye mixture processes has an extremely excellent reflection ratio and stability.

Cyanine dye I of the cyanine dye mixture has a phenylester group which is a electron-drawing group, so that the cyanine dye mixture is more stable than a conventional mixture used as a recording layer. Furthermore, cyanine dye I is a kind of light sensitizer, which can be used to reduce the writing and recording power and decreasing jitter values.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A high-density recordable optical recording disk with a cyanine dye mixture as a recording layer, wherein the cyanine dye mixture comprises:
cyanine dye I having the general structure formula as follows: 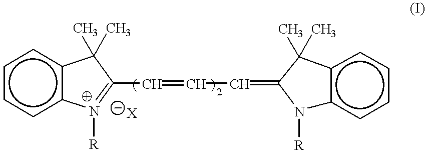
wherein R is a phenylester group.
cyanine dye II having the general structure formula as follows:

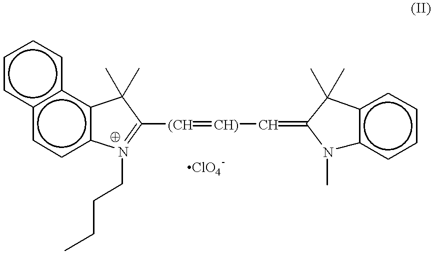

2. The high-density recordable optical recording disk according to claim 1, wherein X⁻ is selected from a group consisting of acid anion, halogen anion, alkylsulfate anion, aeylsulfonate anion and perchlorate anion.

3. The high-density recordable optical recording disk according to claim 1, wherein the weight percentage of cyanine dye I to the total solution is about 0.5-8%.

4. The high-density recordable optical recording disk according to claim 1, wherein the weight percentage of cyanine dye I to the total solution is about 15-4%.

5. The high-density recordable optical recording disk according to claim 1, wherein the weight percentage of cyanine dye I to cyanine dye II is about 1-8%.

6. The high-density recordable optical recording disk according to claim 1, wherein the weight percentage of cyanine dye I to cyanine dye II is about 4-6%.

7. The high-density recordable optical recording disk according to claim 1, wherein the cyanine dye mixture further comprises a photo-stabilizer III having the general structure formula as follows:

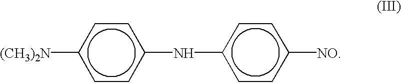

8. The high-density recordable optical recording disk according to claim 7, wherein the weight percentage of cyanine dye I and cyanine dye II to the total solution is about 0.5-8%.

9. The high-density recordable optical recording disk according to claim 7, wherein the weight percentage of cyanine dye I and cyanine dye II to the total solution is about 1-4%.

10. The high-density recordable optical recording disk according to claim 7, wherein the weight percentage of cyanine dye I to cyanine dye II is about 1-15%, and the weight percentage of the photo-stabilizer III to cyanine dye II is about 1-15%.

11. The high-density recordable optical recording disk according to claim 7, wherein the weight percentage of cyanine dye I to cyanine dye II is about 4-6%, and the weight percentage of the photo-stabilizer III to cyanine dye II is about 3-8%.

12. A high-density recordable optical recording disk with a cyanine dye mixture as a recording layer, wherein the cyanine dye mixture comprises:
cyanine dye I having the general structure formula as follows: 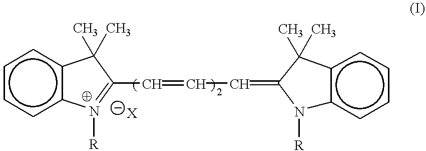
cyanine dye II having the general structure formula as follows: 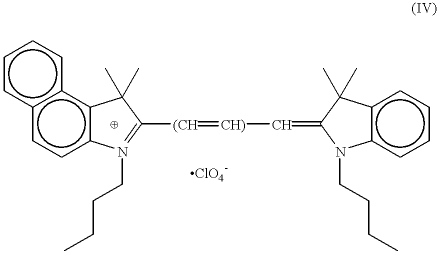
wherein R is a phenylester group.

13. The high-density recordable optical recording disk according to claim 12, wherein X⁻ is selected from a group consisting of acid anion, halogen anion, alkylsulfate anion, aeylsulfonate anion and perchlorate anion.

14. The high-density recordable optical recording disk according to claim 12, wherein the weight percentage of cyanine dye I to the total solution is about 0.5-8%.

15. The high-density recordable optical recording disk according to claim 12, wherein the weight percentage of cyanine dye I to the total solution is about 15-4%.

16. The high-density recordable optical recording disk according to claim 12, wherein the weight percentage of cyanine dye I to cyanine dye IV is about 1-8%.

17. The high-density recordable optical recording disk according to claim 12, wherein the weight percentage of cyanine dye I to cyanine dye IV is about 4-6%.

18. The high-density recordable optical recording disk according to claim 12, wherein the cyanine dye mixture further comprises a photo-stabilizer III having the general structure formula as follows:

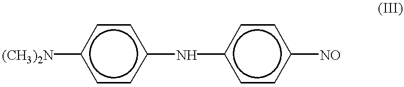

19. The high-density recordable optical recording disk according to claim 18, wherein the weight percentage of cyanine dye I and cyanine dye IV to the total solution is about 0.5-8%.

20. The high-density recordable optical recording disk according to claim 18, wherein the weight percentage of cyanine dye I and cyanine dye IV to the total solution is about 1-4%.

21. The high-density recordable optical recording disk according to claim 18, wherein the weight percentage of cyanine dye I to cyanine dye IV is about 1-15%, and the weight percentage of the photo-stabilizer III to cyanine dye IV is about 1-15%.

22. The high-density recordable optical recording disk according to claim 18, wherein the weight percentage of cyanine dye I to cyanine dye IV is about 4-6%, and the weight percentage of the photo-stabilizer III to cyanine dye IV is about 3-8%.
